(19) United States
(12) Patent Application Publication
(10) Pub. No.: US 2010/0085406 A1
(43) Pub. Date: Apr. 8, 2010

(54) Printing Method for Printing Press and Printing Press

(75) Inventor: Takashi Kimura, Fuchu-shi (JP)

Correspondence Address: TIPS GROUP;c/o Intellevate LLC, P. O. BOX 52050, Minneapolis, MN, 55402, US

(73) Assignee: RYOBI LTD., Fuchu-shi (JP)

(21) Appl. No.: 12/566,608

(22) Filed: Sep. 24, 2009

(30) Foreign Application Priority Data
Oct. 7, 2008 (JP) 2008-260504

(51) Int. Cl. B41J 2/01

(52) U.S. Cl. 347/102

(57) ABSTRACT

An object is to provide a printing method for a printing press and a printing press that are capable of providing advantages in terms of service life, heat generation, and power consumption while overcoming various problems caused by ultraviolet irradiation. The method includes: printing an image on a sheet of paper fed using an ultraviolet curable paint; and irradiating the ultraviolet curable paint on the printed sheet fed by irradiating the ultraviolet curable paint with ultraviolet light from a plurality of light emitting diodes disposed at predetermined intervals across the transverse direction of the sheet, thereby curing the ultraviolet curable paint, wherein all the light emitting diodes are turned on while shielding a predetermined area in the transverse direction of the sheet from ultraviolet light.

### CROSS REFERENCE TO RELATED APPLICATION

This application claims priority from Japanese Patent Application No. 2008-260504, which is incorporated herein by reference.

### BACKGROUND OF THE INVENTION

1. Field of the Invention

The present invention relates to a printing method for a printing press and a printing press, the method involving printing images on sheets of paper fed using ultraviolet curable paints, and irradiating the ultraviolet curable paints on the printed sheets fed with ultraviolet light from light emitting diodes so as to cure the paints. The “paints” as used herein include inks as well as varnishes for use in surface protection and gloss finishing of ink-printed materials.

2. Related Art

Printing presses that perform printing with ultraviolet curable inks have been used heretofore, and for curing the ultraviolet curable inks on the sheets of paper by mean of ultraviolet irradiation, there is proposed a printing press including a single ultraviolet lamp (e.g., a mercury lamp or a xenon lamp) of a size slightly longer than the width of a sheet-conveying cylinder (e.g., see Japanese Patent No. 2006-297690 (FIG. 5)).

The printing press sometimes performs printing on a sheet of a smaller width than the cylinder. As shown in FIG. 3, in order to cure the ultraviolet curable inks on a sheet P of a smaller width than a cylinder 3 while the sheet P is being conveyed, ultraviolet light are applied thereto from an ultraviolet lamp 200 located above the cylinder 3; in this case, the ultraviolet light are thrown also on exposed surfaces 3A and 3B on both lateral ends at the right and left of the cylinder 3, which leads to corrosion of the metallic cylinder 3, deterioration of accuracy in registration of the sheet P due to thermal expansion of the cylinder 3, and in addition, cure of some ultraviolet ink misted over the exposed surfaces 3A and 3B of the cylinder 3 and adhered thereto as a result of ultraviolet irradiation.

And besides, the aforementioned lamp not only is short in service life but also generates much heat and consumes much power. For this reason, a printing press adopting light emitting diodes capable of ultraviolet radiation has been proposed recently (e.g., see Japanese Unexamined Patent Publication No. 2005-238562 (FIG. 1)).

Although the configuration as disclosed in Japanese Unexamined Patent Publication No. 2005-238562, which uses light emitting diodes, is advantageous in terms of service life, heat generation, and power consumption, the configuration still involves a problem as described above of corrosion of exposed portions in the case of applying ultraviolet light to a sheet of paper of a smaller width than a cylinder, which calls for further improvement.

In the meantime, it is conceivable to adopt an arrangement where the light emitting diodes are turned on and off according to the width of a sheet, and more specifically, of them, light emitting diodes located corresponding in position to the sheet are turned on, and the residual light emitting diodes, which are to irradiate the surface of a cylinder exposed to the outside from the sheet are turned off. However, this arrangement still poses a problem and thus is unlikely to be realized.

That is, the light emitting diodes to be turned on are different in total light time from the light emitting diodes to be turned off, which causes fluctuation in service life of each light emitting diode. Because of this, it is difficult to keep track of the replacement timing of each of the light emitting diodes. Therefore, it is difficult to carry out the replacement work for each of the light emitting diodes, which is disadvantageous from the view point of maintenance.

The above individual ON-OFF control for the light emitting diodes is not only difficult to be made, but also poses a problem of increasing the costs of a control device for it. Especially, the light emitting diodes for use in high-speed off-set printing press must be high performance diodes with high irradiation power, which may make light emitting diodes themselves expensive and further increase the costs of the printing press.

Furthermore, although a light emitting diode has light converging capability, it has light which is scattered to some extent, which makes it difficult to set the range of irradiation with high accuracy by turning on and off the light emitting diodes individually. This results in irradiation of ultraviolet light onto portions other than a sheet, and hence onto the surface of a cylinder. Especially, for the above-mentioned high performance light emitting diodes with high irradiation power, light irradiated on the surface of a cylinder exposed to the outside from the sheet may cause corrosion, in the same manner as described above.

### SUMMARY OF THE INVENTION

The present invention has been conceived in view of the foregoing problems, and it is an object of the present invention to provide a printing method for a printing press and a printing press that are capable of providing advantages in terms of service life, heat generation, and power consumption while overcoming various problems caused by ultraviolet irradiation.

According to one aspect of the present invention, there is provided a printing method for a printing press that includes: printing an image on a sheet of paper fed using an ultraviolet curable paint; and irradiating the ultraviolet curable paint on the printed sheet fed by irradiating the ultraviolet curable paint with ultraviolet light from a plurality of light emitting diodes disposed at predetermined intervals across the transverse direction of the sheet, thereby curing the ultraviolet curable paint, wherein all the light emitting diodes are turned on while shielding a predetermined area in the transverse direction of the sheet from ultraviolet light.

According to another aspect of the present invention, there is provided a printing press that includes: a printer section for printing an image on a sheet of paper fed using an ultraviolet curable paint; an ultraviolet irradiator section for curing the ultraviolet curable paint on the printed sheet fed, the ultraviolet irradiator section including a plurality of light emitting diodes arranged at predetermined intervals across the transverse direction of the sheet; a lighting control part for simultaneously turning on all the light emitting diodes; and a shielding part movable in the transverse direction of the sheet for shielding a predetermined area in the transverse direction of the sheet from ultraviolet light emitted from the plurality of light emitting diodes.

With the above arrangement where all the light emitting diodes for irradiating each sheet with ultraviolet light are turned on, it is possible to not only easily keep track of the total light time of each of the light emitting diodes on the basis of the information such as the operation time of the printing press, but also enable replacement of all the light emitting diodes rather than replacement of a part of the light emitting diodes.

It is possible to irradiate only a predetermined area in the lateral direction of the sheet with high accuracy by moving the shielding part in the transverse direction of the sheet according to the width of the sheet or in order to irradiate the predetermined area in the transverse direction of the sheet.

According to the printing method of the present invention, it is possible to adopt a step where the light emitting diodes are turned on at or just before the time when a leading end of the sheet in the conveying direction reaches an irradiation area of the light emitting diodes, and are turned off at or after the time when a trailing end of the sheet in the conveying direction moves out of the irradiation area of the light emitting diodes. According to the printing press of the present invention, the lighting control part may be operated so that the light emitting diodes are turned on at or just before the time when a leading end of the sheet in the conveying direction reaches an irradiation area of the light emitting diodes, and are turned off at or after the time when a trailing end of the sheet in the conveying direction moves out of the irradiation area of the light emitting diodes.

With the above ON-OFF control of the light emitting diodes, the total light time of the light emitting diodes can be shorten compared with the case where the light emitting diodes are kept turned on and thus the time for replacement of the light emitting diodes can be extended.

According to the printing press of the present invention, the shielding part is formed by a pair of UV-cut glasses respectively disposed on the opposite lateral sides of the sheet, and the printing press further includes a driving mechanism for moving at least one of the pair of UV-cut glasses in the transverse direction of the sheet.

The shielding part can be reduced in weight by adopting the UV-cut glasses as compared with the case where the shielding part is formed by a sheet metal or the like, so that a driving power of the driving mechanism for driving the shielding part can be reduced by an amount corresponding to this reduced weight.

With the arrangement where the shielding part for shielding the predetermined area in the transverse direction of the sheet from ultraviolet light is moved in the transverse direction of the sheet while all the light emitting diodes are kept turned on, it is possible to provide a printing method for a printing press and the printing press that are capable of securely preventing any areas other than the sheet from being irradiated with ultraviolet light of the light emitting diodes, which is advantageous in terms of service life, heat generation, and power consumption while being capable of overcoming various problems caused by ultraviolet irradiation including corrosion of cylinders, deterioration of accuracy in registration due to thermal expansion of the cylinders, and adhesion of ultraviolet curable paints.

In addition, the printing method for a printing press and the printing press are capable of keeping track of the total light time of the light emitting diodes on the basis of information such as the operation time of the printing press, as well as are advantageous from the maintenance aspect of view, in which all the light emitting diodes can not only replaced once the total light time reaches a predetermined time for replacement, but also can be instantly and easily replaced with new ones.

### BRIEF DESCRIPTION OF THE DRAWINGS

FIG. 1 is a side view showing an exemplary schematic configuration of a printing press;

FIGS. 2A, 2B and 2C show the inside of a drying unit, in which FIG. 2A is a front view of an essential portion of the drying unit, FIG. 2B is a perspective view showing the structure of the essential portion and a control section, and FIG. 2C is a front view of a substrate with light emitting diodes thereon.

FIG. 3 is a perspective view showing a conventional irradiation lamp.

### DESCRIPTION OF THE PREFERRED EMBODIMENTS

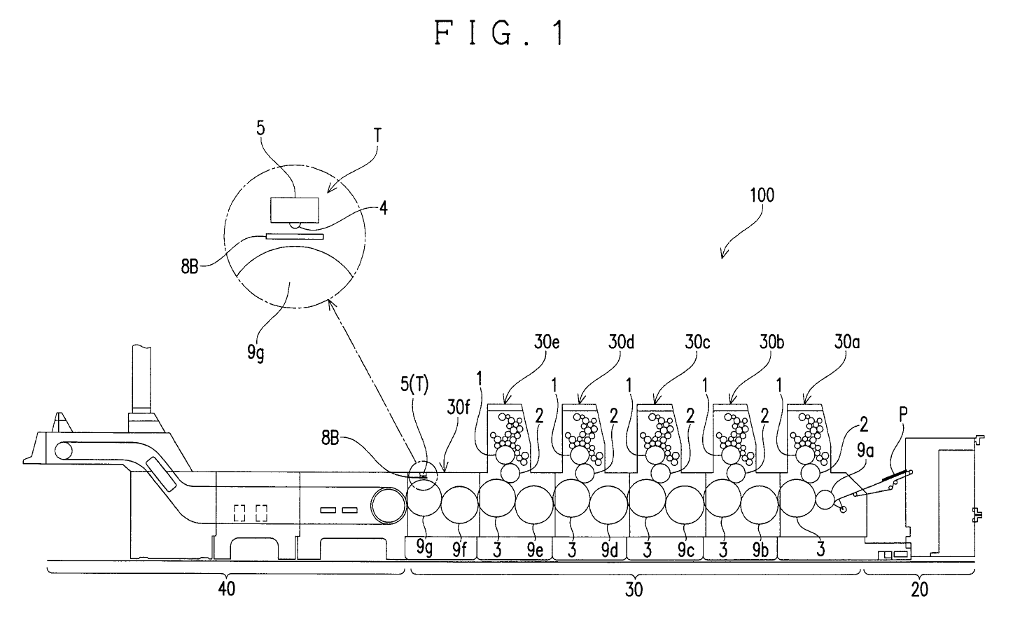

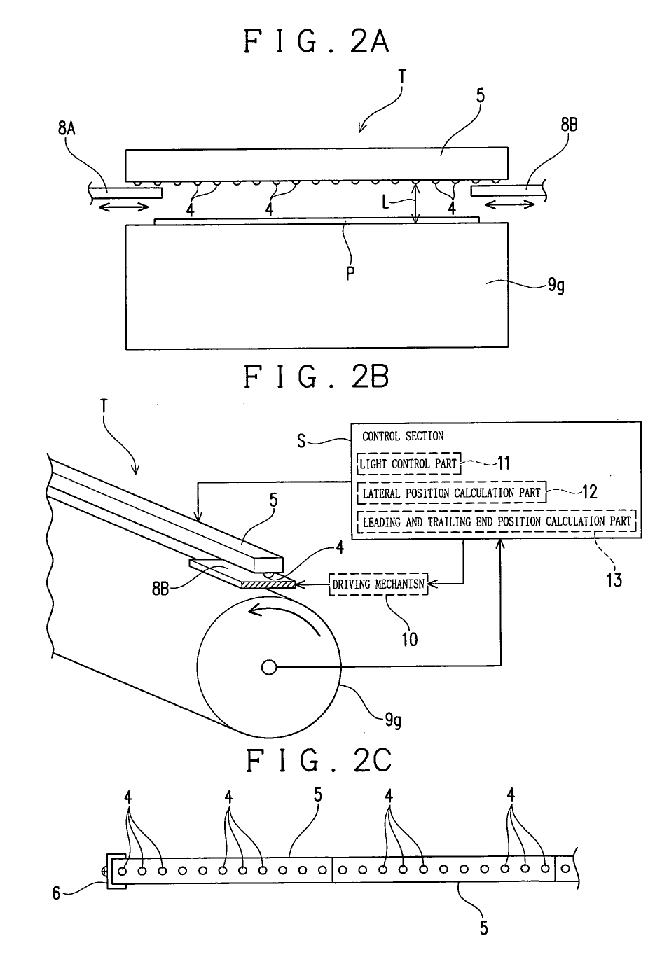

Embodiments of the present invention are described below with reference to the drawings. FIG. 1 shows an exemplary schematic configuration of a printing press 100 for implementing a printing method for a printing press according to the present invention. The printing press includes a control section S shown in FIG. 2 to be described later.

The printing press 100 is adapted to perform printing in five colors with inks of four basic colors that are different from one another, i.e., cyan (C), magenta (M), yellow (Y), and black (Bk), in addition to a special color, e.g., gold, silver, a fluorescent color, or a pearlized color for special color printing or complementary color printing. The printing press 100 includes a sheet feeder section 20, a printer section 30, and a sheet discharge section 40. The sheet feeder section 20 is capable of feeding sheets of paper P (hereinafter referred simply to as sheets P) into the printer section 30. The printer section 30 is capable of performing printing on the sheets fed from the sheet feeder section 20 and includes a plurality of printing units (five printing units 30a to 30e that create basic color images in C, M, Y, and Bk and a special color image through special color printing or complementary color printing, respectively). The sheet discharge section 40 is capable of discharging the sheets that have been printed in the printer section 30 into a stack of sheets along a vertical direction.

Ultraviolet curable inks (hereinafter simply referred to as inks) are used as the inks, and a drying unit 30f is coupled to the rear end of the printing unit 30e located at the position corresponding to the terminal end of each sheet for curing the inks on the printed sheets that have been passed through the printing units 30a to 30e.

In the printing press 100, sheets P are fed from the sheet feeder section 20 into the printer section 30, are printed at the printing units 30a to 30e in the printer section 30, and are then provided to the drying unit 30f for cure of the inks, so as to be discharged at the sheet discharge section 40. Before sheets P are fed from the sheet feeder section 20 into the printer section 30, the sheets P are located (registered) at a predetermined position along the conveying direction and the right-to-left lateral direction. After the registration, the sheets are conveyed to the sheet discharge section 40 while being held in the registered state.

The printing units 30a to 30e of the printer section 30 each include a plate cylinder 1, a rubber cylinder 2, and an impression cylinder 3 as a set of main components. The printing unit 30a includes a transfer cylinder 9a for transferring the sheets P from the sheet feeder section 20 to the impression cylinder 3 of the printing unit 30a, and the printing units 30b to 30e include transfer cylinders 9b to 9e for transferring the printed sheets P to the impression cylinders 3 of the printing units 30b to 30e. These transfer cylinders 9a to 9e and the impression cylinders 3 are provided with grippers (not shown) for holding and conveying the sheets P and transferring the sheets P to an adjacent cylinder in the conveying direction in a cooperative manner.

Printing plates are arranged on the respective plate cylinders 1 in the printing units 30a to 30e. An ink and water are supplied to each plate, and the ink is transferred onto a rubber cylinder 2 following the plate. Then, the ink transferred on the rubber cylinder 2 is further transferred onto an upcoming sheet while being held between the rubber cylinder 2 and an impression cylinder 3 opposing the rubber cylinder 2. In this manner, printing can be performed sequentially on the sheets fed from the sheet feeder section 20 based on the respective plates arranged on the five plate cylinders 1.

Provided inside the drying unit 30f are two transfer cylinders 9f, 9g for conveying sheets printed and conveyed, and an ultraviolet irradiator section T located above the transfer cylinder 9g, which is closer to the trailing end of each conveyed sheet than the transfer cylinder 9f is, for irradiating the inks on the printed sheets conveyed thereto with ultraviolet light to cure the inks.

As also shown in FIGS. 2A, 2B and 2C, the ultraviolet irradiator section T includes a large number of light emitting diodes (hereinafter referred to as LEDs) 4 that have an irradiation axis along a direction substantially orthogonal to the surface of the transfer cylinder 9g, the LEDs 4 being disposed above the transfer cylinder 9g. It is preferred that the LEDs 4 be disposed as closely as possible relative to the transfer cylinder 9g in terms of cure efficiency but be disposed so as riot to touch the incoming sheets P. The interval L is, for example, about 20 mm.

The aforesaid large number of the LEDs 4 are arranged at predetermined (equal) intervals in a straight line along the transverse direction of sheets (the transfer cylinder 9g) so that ultraviolet light can be irradiated over the entire lateral area of the transfer cylinder 9g.

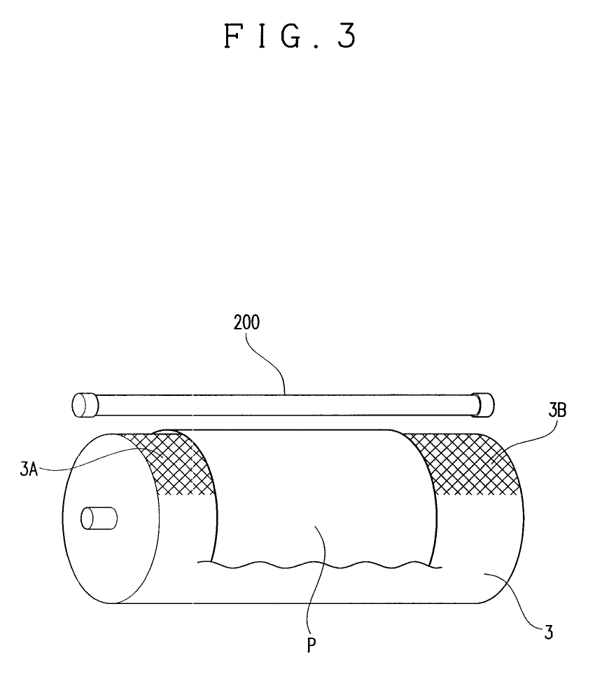

A predetermined number (e.g., eleven) of the large number of the LEDs 4 are each included in a transversally elongate substrate 5, and a total of four substrates 5 are serially coupled to each other in the transverse direction of the sheets (the impression cylinder 3). Supports 6 (only one of which is shown in FIG. 3B) are fixed to the ends of both the outermost substrates 5, such that the four substrates 5 are supported with the right and left supports 6 at a predetermined distance (a predetermined height) from the surface of the transfer cylinder 9g. Herein, forty four LEDs 4 are provided for example, and this number can be freely changed.

A shielding part 8 for shielding a predetermined area in the transverse direction of the sheets from ultraviolet light is provided so as to be movable in the transverse direction of the sheets. The shielding part 8 is formed by a pair of UV-cut glasses 8A and 8B arranged on the opposite lateral sides of the sheet, and a driving mechanism 10 is provided to move the pair of UV-cut glasses 8A and 8B in the transverse direction of the sheet. The driving mechanism 10 may include a sliding member (not shown) for movably supporting both the pair of UV-cut glasses 8A and 8B in the transverse direction of the sheet and an electric motor (not shown) for moving the UV-cut glasses 8A and 8B in the transverse direction of the sheet, while it is possible to freely modify the specific structure of the driving mechanism 10.

The control section S includes a light control part 11 for simultaneously turning on all the LEDs 4 or simultaneously switching all the LEDs 4 from on to off. The light control part 11 may turn on all the LEDs 4 by the start of the printing and turn off all the LEDs 4 by the finish of the printing. In this regard, for example, the ON-OFF control of the LEDs 4 may be made by detecting the position of a sheet relative to the transfer cylinder 9h on the basis of the detected information from a detecting part (specifically, a rotary encoder) that detects the rotational angle of the transfer cylinder 9h, thereby enabling shorting of the light time of the LEDs 4. Consequently, it is possible to produce an advantageous effect of extending the service life of the LEDs 4. The position of the sheet P relative to the transfer cylinder 9h can be obtained from data calculated from prepress data, and more specifically the position of the sheet P relative to the transfer cylinder 9h can be obtained by previously inputting the data into the control section S and finding the matching between the data and the detected information from the detecting part.

Furthermore, the control section S includes a lateral position calculation part 12 for calculating the positions of the opposite lateral ends of the sheet P from prepress data, and a leading and trailing end position calculation part 13 for calculating both the leading end and the trailing end, of the sheet in the conveying direction. Accordingly, the control section S moves the UV-cut glasses 8A and 8B in the transverse direction of the sheet P by driving the driving mechanism 10 on the basis of the positions of the opposite lateral ends of the sheet P detected by the lateral position calculation part 12 to prevent portions other than the sheet P, that is, the surface areas of the transfer cylinder 9h on which the opposite lateral ends of the sheet P are respectively located, from being irradiated with ultraviolet light. In addition, the control section S turns on and off the LEDs 4 on the basis of the positions of the leading end and the trailing end, of the sheet in the conveying direction calculated by the leading and trailing end position calculation part 13. That is, the control section S simultaneously turns on all the LEDs 4 at or just before the time when the leading end of the sheet reaches an irradiation area of the LEDs 4, and simultaneously turns off all the LEDs 4, which have been turned on, at or after the time when the trailing end of the sheet moves out the irradiation area of the LEDs 4. With this operation, all the LEDs 4 are turned off for the area where no sheet P exists. Thus, this operation is advantageous in terms of heat generation and power consumption as compared with the case where all the LEDs 4 are kept turned on during printing operation.

In FIG. 2A, the control section S performs the control to move the UV-cut glasses 8A and 8B in the transverse direction of the sheet P according to the lateral size (width) of the sheet P, and may perform the control to move the UV-cut glasses 8A and 8B in the transverse direction of the sheet P according to not the lateral size of the sheet P but the lateral size of an image on the sheet P.

In the aforesaid embodiment, the control section S turns on and off the LEDs 4 on the basis of the positions of the leading end and the trailing end, of the sheet calculated by the leading and trailing end position calculation part 13. Alternatively, the control section S may turn on and off the LEDs 4 on the basis of the leading end and the trailing end, of an image printed on the sheet. That is, the control section S turns on the LEDs 4 at a position corresponding to the leading end of the image and turns off the LEDs 4 at a position corresponding to the trailing end of the image.

The control section S may be provided with a timing adjustment part for adjusting the ON-timing of the LEDs 4 in synchronization with the conveying speed of the sheet P so as not to cause delay in the ON-timing of the LEDs 4 due to the conveying speed of the sheet P. Accordingly, when the conveying speed of the sheet detected by a conveying speed detecting part for detecting the conveying speed of sheets is inputted into the timing adjustment part, the timing adjustment part retrieves data representative of the ON-timing of the LEDs 4 corresponding to the conveying speed detected from among previously stored data, and thus can adjust the ON-timing of the LEDs 4 on the basis of the retrieved data.

In the aforesaid embodiment, only the inks are exemplified as the paints of the present invention. Alternatively, varnishes or adhesive for use in surface protection and gloss finishing of ink-printed materials may be used.

In the aforesaid embodiment, the shielding part 8 is formed by the pair of the UV-cut glasses disposed on the opposite lateral sides of the sheet to produce an advantageous effect of reducing the weight in comparison with the case where the shielding part 8 is formed by a sheet metal or the like. Alternative to a sheet metal or the like, wood or plastic materials may be used.

This specification is by no means intended to restrict the present invention to the preferred embodiments set forth therein. Various modifications to the printing method for printing and the printing press, as described herein, may be made by those skilled in the art without departing from the spirit and scope of the present invention as defined in the appended claims.

What is claimed is:

1. A printing method for a printing press comprising:
printing an image on a sheet of paper fed using an ultraviolet curable paint; and
irradiating the ultraviolet curable paint on the printed sheet fed with ultraviolet light from a plurality of light emitting diodes disposed at predetermined intervals across the transverse direction of the sheet, thereby curing the ultraviolet curable paint,
wherein all the light emitting diodes are turned on while shielding a predetermined area in the transverse direction of the sheet from ultraviolet light.

2. The method according to claim 1, wherein
the light emitting diodes are turned on at or just before the time when a leading end of the sheet in the conveying direction reaches an irradiation area of the light emitting diodes, and are turned off at or after the time when a trailing end of the sheet in the conveying direction moves out of the irradiation area of the light emitting diodes.

3. A printing press comprising:
a printer section for printing an image on a sheet of paper fed using an ultraviolet curable paint;
an ultraviolet irradiator section for curing the ultraviolet curable paint on the printed sheet fed, the ultraviolet irradiator section including a plurality of light emitting diodes arranged at predetermined intervals across the transverse direction of the sheet;
a lighting control part for simultaneously turning on all the light emitting diodes; and
a shielding part for shielding a predetermined area in the transverse direction of the sheet from ultraviolet light emitted from the plurality of light emitting diodes.

4. The printing press according to claim 3, wherein
the light emitting diodes are turned on at or just before the time when a leading end of the sheet in the conveying direction reaches an irradiation area of the light emitting diodes, and are turned off at or after the time when a trailing end of the sheet in the conveying direction moves out of the irradiation area of the light emitting diodes.

5. The printing press according to claim 3, wherein
the shielding part comprises a pair of UV-cut glasses respectively disposed on the opposite lateral sides of the sheet, and the printing press further comprises a driving mechanism for moving at least one of the pair of UV-cut glasses in the transverse direction of the sheet.

6. The printing press according to claim 4, wherein
the shielding part comprises a pair of UV-cut glasses respectively disposed on the opposite lateral sides of the sheet, and the printing press further comprises a driving mechanism for moving at least one of the pair of UV-cut glasses in the transverse direction of the sheet.
